(19) United States
(12) Patent Application Publication
(10) Pub. No.: US 2012/0294645 A1
(43) Pub. Date: Nov. 22, 2012

(54) IMAGE FORMING APPARATUS

(75) Inventors: Toshihiro Shimada, Kanagawa (JP); Hiroshi Ishii, Kanagawa (JP)

(73) Assignee: RICOH COMPANY, LTD., Tokyo (JP)

(21) Appl. No.: 13/460,959

(22) Filed: May 1, 2012

(30) Foreign Application Priority Data
May 20, 2011 (JP) 2011-113460
Apr. 19, 2012 (JP) 2012-095843

(51) Int. Cl. G03G 15/00; G03G 15/20

(52) U.S. Cl. 399/110; 399/320

(57) ABSTRACT

An image forming apparatus including an image forming part to form an image on a recording medium, a sheet feeder to feed the recording medium to the image forming part, a drawer unit withdrawably installable in the image forming apparatus disposed within the image forming pat, and a front cover mounted on the drawer unit. The front cover is closably openable relative to the image forming apparatus with movement of the drawer unit.

### CROSS-REFERENCE TO RELATED APPLICATIONS

The present patent application is based on and claims priority pursuant to 35 U.S.C. §119 from Japanese Patent Application Nos. 2011-113460, filed on May 20, 2011, and 2012-095843, filed on Apr. 19, 2012, both in the Japan Patent Office, each of which is incorporated by reference herein in its entirety.

### BACKGROUND OF THE INVENTION

1. Field of the Invention

Exemplary aspects of the present invention generally relate to an image forming apparatus using an electrophotographic method, an electrostatic recording method, and so forth, such as a copier, a printer, a facsimile machine, and a multifunction device having two or more of copying, printing, and facsimile capabilities, and more particularly to an image forming apparatus including a built-in unit withdrawably installable in the image forming apparatus from a front side of the image forming apparatus.

2. Description of the Related Art

Related-art image forming apparatuses, such as copiers, printers, facsimile machines, and multifunction devices having two or more of copying, printing, and facsimile capabilities, typically form a toner image on a recording medium (e.g., a sheet of paper, etc.) according to image data using, for example, an electrophotographic method. In the electrophotographic method, for example, a charger charges a surface of an image carrier (e.g., a photoconductor); an irradiating device emits a light beam onto the charged surface of the photoconductor to form an electrostatic latent image on the photoconductor according to the image data; a developing device develops the electrostatic latent image with a developer (e.g., toner) to form a toner image on the photoconductor; a transfer device transfers the toner image formed on the photoconductor onto a sheet of recording media; and a fixing device applies heat and pressure to the sheet bearing the toner image to fix the toner image onto the sheet. The sheet bearing the fixed toner image is then discharged from the image forming apparatus.

Such an image forming apparatus generally includes a closably openable large front cover that shields various units within the image forming apparatus and operates in conjunction with an interlock switch. The front cover is opened to remove jammed recording media from its conveyance path or to replace units. In addition, when the front cover is opened, the interlock switch is turned off to prevent the image forming apparatus from operating.

FIG. 1 is a perspective view illustrating an example of a configuration of a related-art image forming apparatus 100. In the image forming apparatus 100, a front cover 101 is constructed of left and right front doors 102 and 103, each of which is hingedly supported at its outboard end and is swung open and closed. Upon, for example, replacement of an image forming unit 104, a user opens both front doors 102 and 103 from the center outward to pull the image forming unit 104 forward out of the image forming apparatus 100. Then, the user sets a new image forming unit 104 in the image forming apparatus 100 and closes the front doors 102 and 103 to complete replacement of the image forming unit 104.

However, in the above example, the front cover 101 and the image forming unit 104 are each provided separately to the image forming apparatus 100. Consequently, opening/closing of the front cover 101 needs to be performed separately from removal/installation of the image forming unit 104 upon replacement of the image forming unit 104. In other words, upon replacement of each unit as well as the image forming unit 104, the user needs to take various steps including: opening the front cover 101, pulling a unit to be replaced out of the image forming apparatus 100; replacing the unit with a new unit; pushing the new unit in to be set in the image forming apparatus 100; and closing the front cover 101. Thus, there is demand for simplifying replacement of units provided within the image forming apparatus 100.

Further, the large size of the front cover 101 and hinges used for supporting the front cover 101 increase production costs and number of components. Therefore, there is also demand for reducing the production costs and the number of components of the image forming apparatus.

### BRIEF SUMMARY OF THE INVENTION

In view of the foregoing, illustrative embodiments of the present invention provide an improved image forming apparatus that facilitates replacement of units provided within the image forming apparatus and removal of jammed recording media at reduced production costs.

In one illustrative embodiment, an image forming apparatus includes an image forming part to form an image on a recording medium, a sheet feeder to feed the recording medium to the image forming part, a drawer unit withdrawablly installable in the image forming apparatus disposed within the image forming part, and a front cover mounted on the drawer unit and closably openable relative to the image forming apparatus with movement of the drawer unit.

Additional features and advantages of the present disclosure will become more fully apparent from the following detailed description of illustrative embodiments, the accompanying drawings, and the associated claims.

### BRIEF DESCRIPTION OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a perspective view illustrating an example of a configuration of a related-art image forming apparatus;

FIG. 2 is a vertical cross-sectional view illustrating an example of a configuration of an image forming apparatus according to illustrative embodiments;

FIG. 3 is a perspective view illustrating the configuration of the image forming apparatus illustrated in FIG. 2;

FIG. 4 is a perspective view illustrating an example of a configuration of a lock mechanism provided to a front cover of an image forming apparatus according to a first illustrative embodiment;

FIGS. 5A and 5B are side views illustrating an example of a configuration of the lock mechanism in locked and unlocked positions, respectively, according to the first illustrative embodiment;

FIG. 6 is a perspective view illustrating an example of a configuration of a lock mechanism provided to a front cover of an image forming apparatus according to a second illustrative embodiment;

FIGS. 7A and 7B are side views illustrating an example of a configuration of the lock mechanism in locked and unlocked positions, respectively, according to the second illustrative embodiment; and

FIG. 8 is a side view illustrating an example of a configuration of an image forming apparatus according to a third illustrative embodiment.

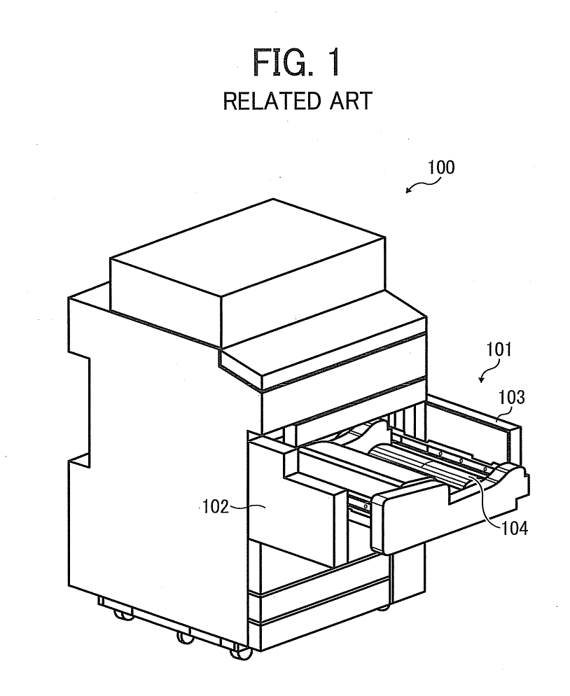

### DETAILED DESCRIPTION OF ILLUSTRATIVE EMBODIMENTS

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Illustrative embodiments of the present invention are now described below with reference to the accompanying drawings.

In a later-described comparative example, illustrative embodiment, and exemplary variation, for the sake of simplicity the same reference numerals will be given to identical constituent elements such as parts and materials having the same functions, and redundant descriptions thereof omitted unless otherwise required.

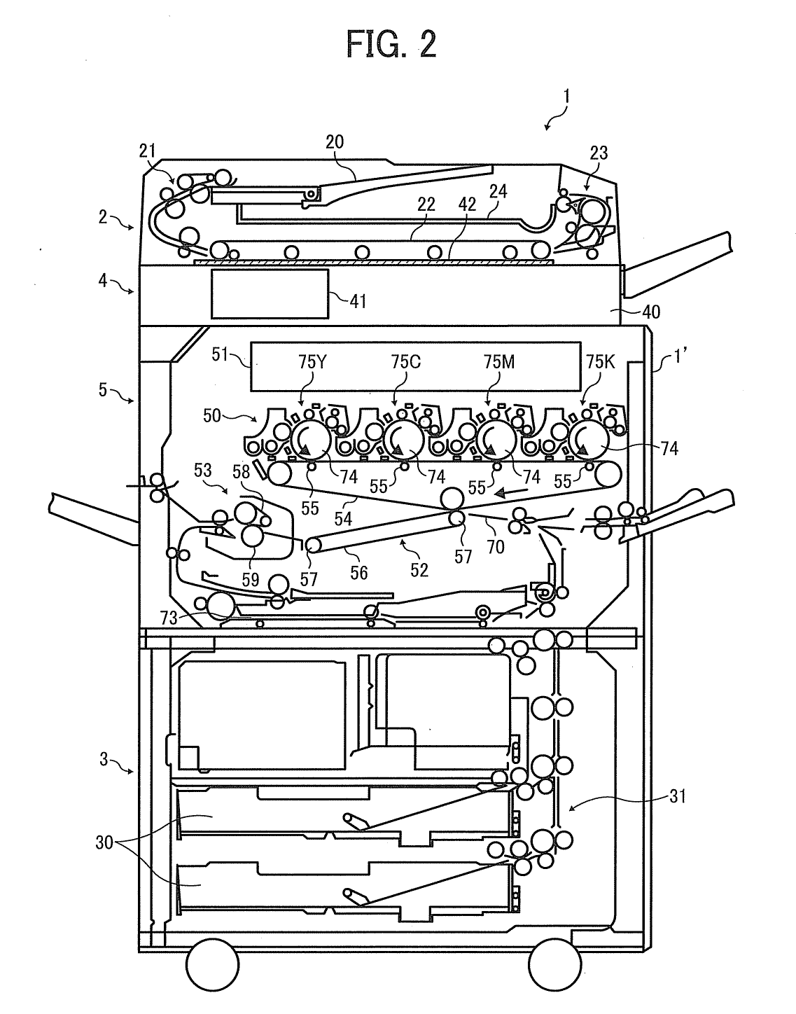

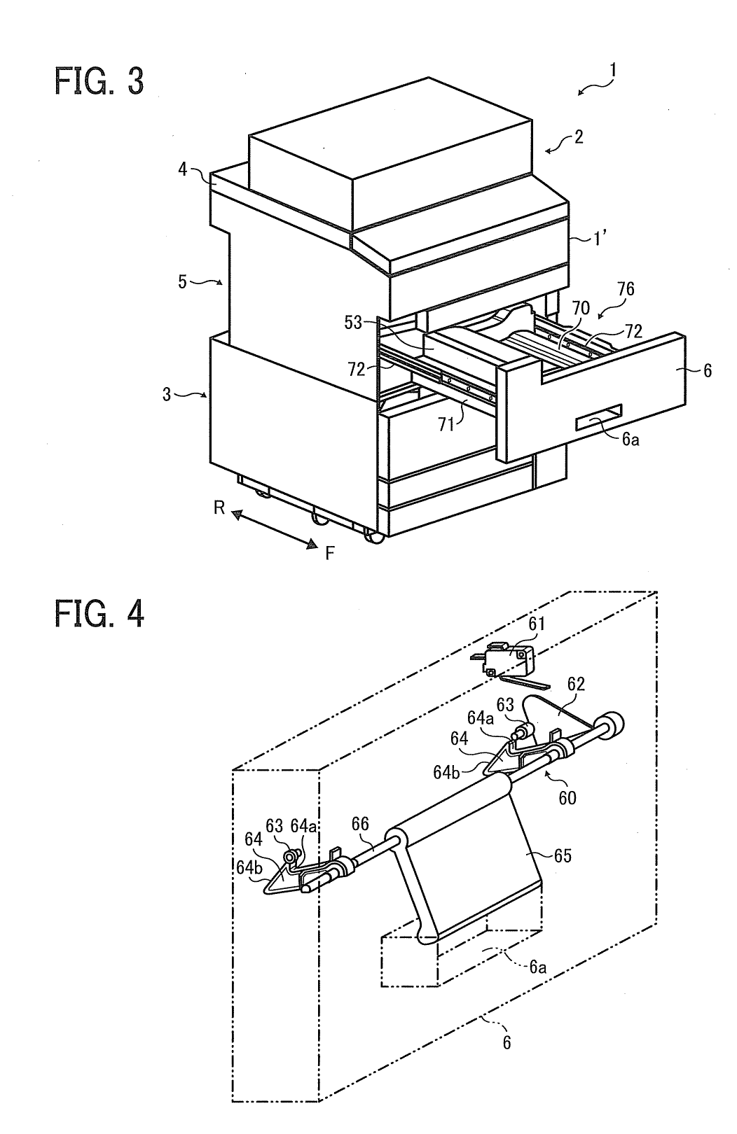

A description is now given of a configuration and operation of an image forming apparatus 1 according to illustrative embodiments, with reference to FIGS. 2 and 3.

FIG. 2 is a vertical cross-sectional view illustrating an example of a configuration of the image forming apparatus 1. FIG. 3 is a perspective view illustrating the configuration of the image forming apparatus 1. In illustrative embodiments, the image forming apparatus 1 is a tandem-type full-color copier.

The image forming apparatus 1 includes an automatic document feeder (ADF) 2 and a body 1′. The body 1′ includes a sheet feeder 3, an image reader 4, and an image forming part 5. A front cover 6 provided to a front part of a drawer unit 76 described in detail later is disposed in a front portion of the image forming part 5. It is to be noted that, in FIG. 3, “F” refers to a front side of the image forming apparatus 1, and “R” refers to a rear side of the image forming apparatus 1.

The ADF 2 includes a document tray 20, a sheet feed roller 21, a conveyance belt 22, a discharge roller 23, and a discharge tray 24. The ADF 2 is hinged to the image forming apparatus 1 to be closably openable relative to the image reader 4 using an open/close mechanism such as a hinge, not shown.

The sheet feed roller 21 separates a stack of documents placed on the document tray 20 sheet by sheet and conveys each sheet of the documents toward the image reader 4. The conveyance belt 22 conveys each sheet of the documents fed from the sheet feed roller 21 to the image reader 4. The discharge roller 23 discharges the documents conveyed by the conveyance belt 22 from the image reader 4 to the discharge tray 24 provided below the document tray 20.

The sheet feeder 3 includes sheet feed cassettes 30 and a sheet feed unit 31. The sheet feed cassettes 30 store recording media such as sheets of paper having a different size, respectively. The sheet feed unit 31 conveys the recording media fed from the sheet feed cassettes 30 to the image forming part 5.

The image reader 4 includes a housing 40, an optical scanning unit 41, a contact glass 42, and a drive unit, not shown.

The optical scanning unit 41 is provided with an LED unit and is included within the housing 40. The LED unit directs light in a main scanning direction, and the drive unit drives the optical scanning unit 41 to scan in a sub-scanning direction throughout an area onto which the light is to be directed. Thus, the optical scanning unit 41 reads two-dimensional color image data of the document.

The contact glass 42 is provided above the housing 40 of the image reader 4 to form an upper surface of the housing 40. The drive unit includes a wire fixed to the optical scanning unit 41, multiple driven pulleys and a drive pulley, around each of which the wire extends, and a motor that rotates the drive pulley.

The image forming part 5 includes a tandem-type image forming device 50, an irradiating unit 51, a secondary transfer unit 52, a fixing unit 53, an intermediate transfer belt 54, primary transfer rollers 55, a main conveyance path 70, and a reversal conveyance path 73.

The irradiating unit 51 is provided above and adjacent to the tandem-type image forming device 50 to irradiate photoconductors 74 with light as described in detail below.

The tandem-type image forming device 50 is provided above the intermediate transfer belt 54 and includes four image forming units 75Y, 75C, 75M, and 75K (hereinafter collectively referred to as image forming units 75), arranged side by side in that order from upstream to downstream in a direction of rotation of the intermediate transfer belt 54, to form a toner image of a specific color, that is, yellow (Y), cyan (C), magenta (M), or black (K). Each of the image forming units 75 includes the corresponding photoconductor 74, and a charger, a developing device, a cleaning device, a neutralizing device, and so forth are provided around the photoconductor 74 to together form a single process cartridge.

In the tandem-type image forming device 50, a toner image of the specified color is formed on each of the photoconductors 74 based on image data of the specified color read by the image reader 4. The toner images thus formed on the respective photoconductors 74 are primarily transferred onto the intermediate transfer belt 54 by the primary transfer rollers 55 and superimposed one atop the other so that a single full-color toner image is formed on the intermediate transfer belt 54.

The secondary transfer unit 52 is disposed opposite the tandem-type image forming device 50 below the intermediate transfer belt 54. The secondary transfer unit 52 includes an endless secondary transfer belt 56 wound around two support rollers 57. The secondary transfer belt 56 is pressed against the intermediate transfer belt 54 so that the full-color toner image formed on the intermediate transfer belt 54 is secondarily transferred onto a recording medium fed from the sheet feeder 3 via the main conveyance path 70. It is to be noted that, in place of the secondary transfer belt 56, a secondary transfer roller may be included in the secondary transfer unit 52.

The fixing unit 53 is provided downstream from the secondary transfer unit 52 in a direction of conveyance of the recording medium. The fixing unit 53 includes an endless fixing belt 58 and a pressing roller 59 pressed against the fixing belt 58. In the fixing unit 53, heat and pressure are supplied to the recording medium from the fixing belt 58 and the pressing roller 59. Accordingly, toner of the toner image transferred onto the recording medium is melted so that the toner image is fixed onto the recording medium.

As illustrated in FIG. 2, the reversal conveyance path 73 is provided below the secondary transfer unit 52 and the fixing unit 53. In the reversal conveyance path 73, the recording medium discharged from the fixing unit 53 is reversed to be conveyed to the secondary transfer unit 52 again via the main conveyance path 70 during duplex image formation in which images are formed on both sides of the recording medium, respectively.

Referring to FIG. 3, the front cover 6 is mounted to a front portion of each of carriers 71. The carriers 71 are supported by rails 72, respectively, to be movable relative to the image forming part 5 in front and rear directions, which are indicated by a double-headed arrow RF in FIG. 3. The secondary transfer unit 52, the fixing unit 53, the main conveyance path 70, and the reversal conveyance path 73 are provided to the carrier 71 to together form the single drawer unit 76. Thus, the front cover 6 is integrally formed with the drawer unit 76, and a user grips an operating recessed portion 6a provided to the front cover 6 to move the front cover 6 in the front and rear directions relative to the image forming part 5 so that the drawer unit 76 is withdrawably installable in the image forming part 5.

The front cover 6 is closably openable along with forward and backward movement of the drawer unit 76 to closably open the front portion of the image forming part 5. The drawer unit 76 is accommodated within the image forming part 5 when the front cover 6 is closed so that the front cover 6 is flush with the body 1′ of the image forming apparatus 1.

As described above, the secondary transfer unit 52, the fixing unit 53, the main conveyance path 70, and the reversal conveyance path 73 are integrally movable as the single drawer unit 76 in the front and rear directions relative to the image forming part 5 while supported by the carriers 71. The drawer unit 76 is accommodated within the image forming part 5 during operation of the image forming apparatus 1. Meanwhile, the drawer unit 76 is pulled out of the image forming part 5 to the front upon replacement of the components provided to the drawer unit 76 or removal of jammed recording media from the image forming part 5.

The front cover 6 includes a lock mechanism 60, an interlock switch 61, and a switching member 62. FIG. 4 is a perspective view illustrating an example of a configuration of the lock mechanism 60 according to a first illustrative embodiment. The lock mechanism 60 includes a stationary member 63, picks 64, an operating member, which, in the present illustrative embodiment, is a lever 65, a support shaft 66, and a torsion coil spring, not shown.

The stationary member 63 is constructed of two pins, each of which is fixed to the image forming part 5, and extends in a horizontal direction. The support shaft 66 is rotatably supported by the front cover 6 and extends in the horizontal direction.

The picks 64 are rotatably provided to the front cover 6 by being fixed to the support shaft 66, respectively. Each of the pick 64 has a notch 64a engageable with the stationary member 63 and a sloped guide surface 64b sloping upward from a rear end of the pick 64.

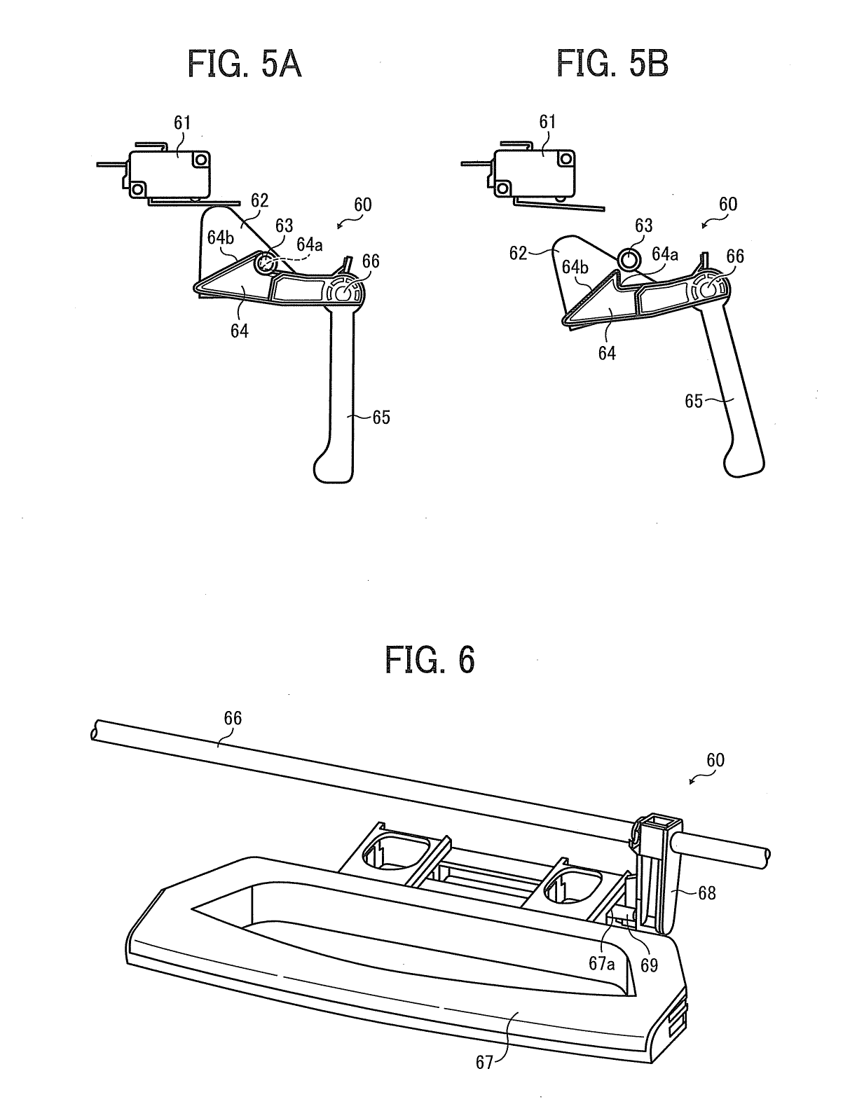

The picks 64 are rotatable between locked and unlocked positions. FIG. 5A is a side view illustrating an example of a configuration of the lock mechanism 60 in the locked position. FIG. 5B is a side view illustrating an example of a configuration of the lock mechanism 60 in the unlocked position. When the front cover 6 is closed, the picks 64 are rotated to the locked position so that the notch 64a of each of the picks 64 engages the stationary member 63 to lock the front cover 6. By contrast, the picks 64 are rotated to the unlocked position so that the notch 64a of each of the picks 64 is disengaged from the stationary member 63 to unlock the front cover 6.

The lever 65 is rotatably provided to the front cover 6 by being fixed to the support shaft 66. The operating recessed portion 6a faulted in a front surface of the front cover 6 exposes a leading end of the lever 65 to outside. The user can grip and rotate the lever 65 through the operating recessed portion 6a so that the lever 65 rotates the picks 64 via the support shaft 66 to move the picks 64 between the locked and unlocked positions.

The torsion coil spring is wound around the support shaft 66 and supplies a force to the picks 64 such that the picks 64 are positioned at the locked position.

The lock mechanism 60 switches the state of the drawer unit 76 and the front cover 6, while the front cover 6 is closed to shield the image forming part 5, between a locked state as illustrated in FIG. 5A to make the drawer unit 76 and the front cover 6 unmovable and an unlocked state as illustrated in FIG. 5B to make the drawer unit 76 and the front cover 6 movable.

The interlock switch 61 is constructed of a microswitch provided to the image forming part 5 to turn on and off the image forming apparatus 1. When the interlock switch 61 is turned on, the image forming apparatus 1 starts operations. By contrast, when the interlock switch 61 is turned off, the image forming apparatus 1 or at least the image forming part 5 does not start operations.

The switching unit 62 is constructed of a cam plate fixed to the support shaft 66 to turn on and off the interlock switch 61. The switching unit 62 turns on the interlock switch 61 when the lock mechanism 60 is in the locked position as illustrated in FIG. 5A, and turns off the interlock switch 61 when the lock mechanism 60 is in the unlocked position as illustrated in FIG. 5B.

A description is now given of operations of the image forming apparatus 1 according to the first illustrative embodiment.

The front cover 6 is closed during image formation performed by the image forming apparatus 1. At this time, the force from the torsion coil spring positions the picks 64 at the locked position as illustrated in FIG. 5A. Accordingly, the notch 64a of each of the picks 64 engages the stationary member 63 to lock the front cover 6. Simultaneously, the switching unit 62 turns the interlock switch 61 on so that the image forming apparatus 1 is ready for operation.

During maintenance of the image forming apparatus 1 such as removal of jammed recording media and replacement of the components provided to the drawer unit 76, the front cover 6 is opened.

To open the front cover 6, first, the user pulls the lever 65 and rotates the lever 65. Accordingly, the lever 65 is rotated against the force from the torsion coil spring so that the picks 64 are rotated to the unlocked position via the support shaft 66 as illustrated in FIG. 5B. At this time, the notch 64a of each of the picks 64 is disengaged from the stationary member 63 to unlock the front cover 6. Simultaneously, the switching unit 62 is rotated so that the interlock switch 61 is turned off to cause the image forming apparatus 1 not to operate.

Thus, the front cover 6 is unlocked, thereby causing the front cover 6 and the drawer unit 76 to be movable to the front. Next, the user grips both the lever 65 and the operating recessed portion 6a of the front cover 6 to pull both the front cover 6 and the drawer unit 76 forward out of the image forming part 5. After the front cover 6 and the drawer unit 76 are sufficiently withdrawn from the image forming part 5, the user releases the lever 65. As a result, the picks 64 are rotated to the locked position by the force from the torsion coil spring.

During maintenance, for example, the user detaches a component of the drawer unit 76 which needs to be replaced from the carriers 71 and attaches a new component to the carriers 71. The user can also remove jammed recording media from the main conveyance path 70 or the reversal conveyance path 73. Upon completion of maintenance, the user pushes the front cover 6 and the drawer unit 76 into the image forming part 5 toward the rear of the image forming apparatus 1.

When the front cover 6 and the drawer unit 76 are set in the image forming part 5, the guide surface 64b of each of the picks 64 contacts the stationary member 63. As a result, the guide surface 64b of each of the picks 64 is guided by the stationary member 63 so that the picks 64 are rotated against the force from the torsion coil spring. When a front end of the guide surface 64b reaches the stationary member 63, the guide surface 64b and the stationary member 63 are separated from each other. Accordingly, the picks 64 are rotated by the force from the torsion coil spring so that the notch 64a of each of the picks 64 engages the stationary member 63 to lock the front cover 6. Simultaneously, the switching unit 62 turns the interlock switch 61 on so that the image forming apparatus 1 is ready for operation.

Thus, in the image forming apparatus 1 according to the first illustrative embodiment, the drawer unit 76 is movable relative to the image forming part 5 along with the opening and closing of the front cover 6. Therefore, upon replacement of the component included in the drawer unit 76, the user simply opens the front cover 6, replaces the component with a new component, and then closes the front cover 6. In the related-art image forming apparatus, however, the user needs to take various steps including: opening the front cover; pulling the image forming unit out of the image forming apparatus; replacing the image forming unit with a new image forming unit; pushing the image forming unit into the image forming apparatus; and closing the front cover. Thus, the image forming apparatus 1 according to the first illustrative embodiment facilitates maintenance thereof, thereby providing user-friendly configuration.

In addition, the front cover 6 can be set smaller than a related-art front cover, which is provided throughout the front portion of the image forming part in the related-art image forming apparatus. Further, the front cover 6 according to the first illustrative embodiment does not need components such as hinges, which are used for the related-art front cover. Thus, number of components provided to the image forming apparatus 1 according to the first illustrative embodiment can be reduced, thereby reducing production costs.

In the image forming apparatus 1 according to the first illustrative embodiment, the front cover 6 is mounted to the front portion of the drawer unit 76. The drawer unit 76 includes the carriers 71 accommodated within the image forming part 5 movably in the front and rear directions and the components such as the secondary transfer unit 52 and the fixing unit 53 that construct a part of the image forming part 5 and are accommodated within the image forming part 5 movably in the front and rear directions along with the opening and closing of the front cover 6 while being supported by the carriers 71. Accordingly, upon maintenance of the image forming part 5 or removal of jammed recording media from the image forming part 5, the user can simply open the front cover 6 to access the component to be replaced or the jammed recording media, thereby considerably facilitating maintenance of the image forming part 5 and removal of the jammed recording media.

The image forming apparatus 1 according to the first illustrative embodiment further includes the lock mechanism 60 that switches the state of the drawer unit 76 and the front cover 6, while the front cover 6 is closed to shield the image forming part 5, between the locked state to cause the drawer unit 76 and the front cover 6 unmovable and the unlocked state to cause the drawer unit 76 and the front cover 6 movable. Therefore, the lock mechanism 60 can lock the front cover 6 to be closed to shield the image forming part 5, thereby preventing the front cover 6 from easily being opened.

The lock mechanism 60 includes the stationary member 63 fixed to the image forming part 5, the picks 64 rotatably provided to the front cover 6, and the lever 65 that rotates the picks 64 between the locked and unlocked positions. When the front cover 6 is closed, the picks 64 are rotated to the locked position so that the picks 64 engage the stationary member 63 to lock the front cover 6, or the picks 64 are rotated to the unlocked position so that the picks 64 are disengaged from the stationary member 63 to unlock the front cover 6. Thus, the lock mechanism 60 can have a simple configuration including the stationary member 63, the picks 64, and the lever 65 as main components, thereby reducing production costs.

The image forming apparatus 1 according to the first illustrative embodiment further includes the interlock switch 61 that turns on and off operations of the image forming part 5, and the switching unit 62 provided to the front cover 6. The switching unit 62 turns on the interlock switch 61 when the front cover 6 is closed, and turns off the interlock switch 61 when the front cover 6 is opened.

Therefore, even when the front cover 6 is closed, the interlock switch 61 is turned off as long as the lock mechanism 60 is in the unlocked state. In a case in which the lever 65 is operated by the user to move the lock mechanism 60 to the unlocked state, it is assumed that the user is about to open the front cover 6 even though the front cover 6 is still closed. Therefore, the interlock switch 61 is turned off when the lock mechanism 60 is switched to the unlocked state, thereby more promptly stopping operations of the image forming part 5.

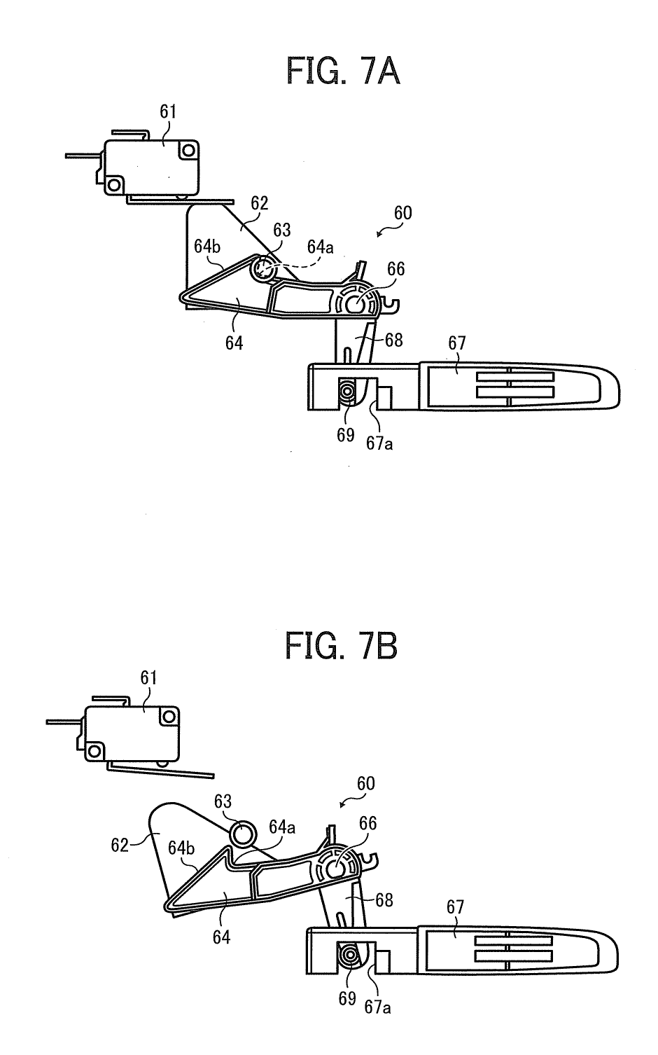

As described above, the lock mechanisms 60 according to the first illustrative embodiment includes the stationary member 63, the picks 64, the lever 65, the support shaft 66, and the torsion coil spring. However, the configuration of the lock mechanism 60 is not limited to the above-described example. Alternatively, as illustrated in FIGS. 6, 7A, and 7B, the lock mechanism 60 may be constructed of the stationary member 63, the picks 64, the support shaft 66, and an operating member, which, in a second illustrative embodiment, is constructed of a handle 67, an arm 68, and the torsion coil spring. FIG. 6 is a perspective view illustrating an example of a configuration of the lock mechanism 60 according to the second illustrative embodiment. FIGS. 7A and 7B are side views illustrating the lock mechanism 60 in locked and unlocked positions, respectively, according to the second illustrative embodiment.

The handle 67 is provided to the operating recessed portion 6a of the front cover 6 and is movable relative to the front cover 6 in the front and rear directions. A downwardly recessed cutout 67a is formed in the rear of the handle 67. The arm 68 is fixed to the support shaft 66, and a protrusion 69 is provided to a leading end of the arm 68.

The protrusion 69 protrudes into and is accommodated within the cutout 67a of the handle 67. Front and rear edges of the cutout 67a are hit against the protrusion 69 by movement of the handle 67 so that the arm 68 is rotated. The configuration of each of the stationary member 63, the picks 64, the support shaft 66, and the torsion coil spring according to the second illustrative embodiment is the same as that of the first illustrative embodiment, and a description thereof is omitted.

In the second illustrative embodiment, the user pulls the handle 67 forward upon maintenance of the image forming apparatus 1. As a result, the rear edge of the cutout 67a of the handle 67 is hit against the protrusion 69 to move the protrusion 69 forward as illustrated in FIG. 7B. Forward movement of the protrusion 69 rotates the arm 68 against the force from the torsion coil spring to move the picks 64 to the unlocked position. Then, the notch 64a of each of the picks 64 is disengaged from the stationary member 63 so that the front cover 6 is unlocked. Simultaneously, the switching unit 62 is rotated so that the interlock switch 61 is turned off to cause the image forming apparatus 1 not to operate.

Thus, because the front cover 6 is unlocked as described above, the front cover 6 and the drawer unit 76 are now movable to the front. The user grips the handle 67 to pull the front cover 6 and the drawer unit 76 to the front out of the image forming part 5. After the front cover 6 and the drawer unit 76 are sufficiently pulled out of the image forming part 5, the user releases the handle 67. Accordingly, the picks 64 are rotated by the force from the torsion coil spring to move the protrusion 69 backward via the support shaft 66 and the arm 68. As a result, the protrusion 69 is hit against the rear edge of the cutout 67a of the handle 67 to move the cutout 67a backward so that the handle 67 is also moved backward.

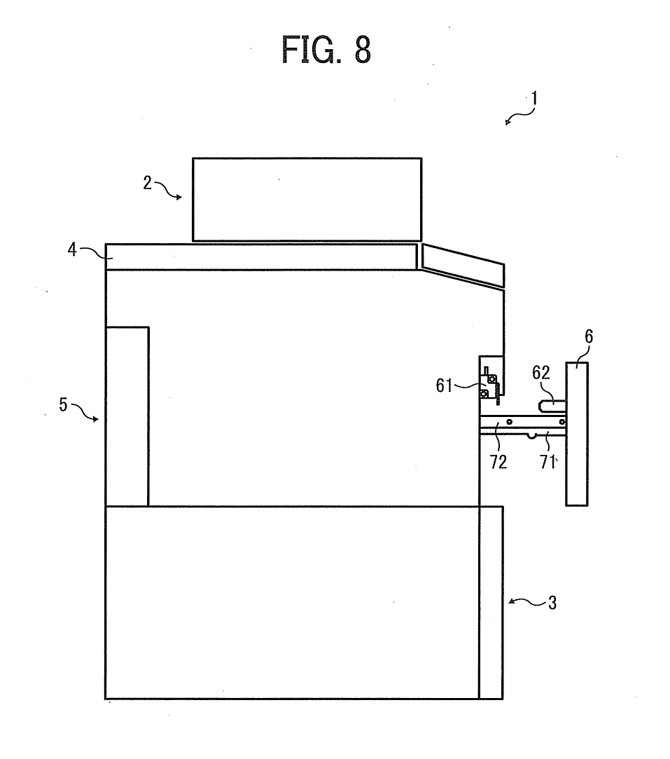

Although the image forming apparatus 1 according to the first and second illustrative embodiments includes the lock mechanism 60 as described above, alternatively, the lock mechanism 60 may not be provided to the image forming apparatus 1 as illustrated in FIG. 8. FIG. 8 is a side view illustrating an example of a configuration of the image forming apparatus 1 according to a third illustrative embodiment. In the third illustrative embodiment, the interlock switch 61 is provided to the front portion of the image forming part 5 and the switching member 62 is constructed of a protrusion provided to a rear part of the front cover 6 to face the interlock switch 61. Thus, the switching member 62 turns on the interlock switch 61 when the front cover 6 is closed, and turns off the interlock switch 61 when the front cover 6 is opened, thereby securely stopping the operations of the image forming part 5 while the front cover 6 is opened.

Although being provided to the front cover 6 in the image forming apparatus 1 according to the foregoing illustrative embodiments, alternatively, the switching member 62 may be provided to the drawer unit 76. In such a case, the switching member 62 is movable relative to the image forming part 5 to turn on and off the interlock switch 61 fixed to the image forming part 5.

Elements and/or features of different illustrative embodiments may be combined with each other and/or substituted for each other within the scope of this disclosure and appended claims.

Illustrative embodiments being thus described, it will be apparent that the same may be varied in many ways. Such exemplary variations are not to be regarded as a departure from the scope of the present invention, and all such modifications as would be obvious to one skilled in the art are intended to be included within the scope of the following claims.

The number of constituent elements and their locations, shapes, and so forth are not limited to any of the structure for performing the methodology illustrated in the drawings.

What is claimed is:

1. An image forming apparatus, comprising:
an image forming part to form an image on a recording medium;
a sheet feeder to feed the recording medium to the image forming part;
a drawer unit withdrawablly installable in the image forming apparatus disposed within the image forming part; and
a front cover mounted on the drawer unit, the front cover being closably openable relative to the image forming apparatus with movement of the drawer unit.

2. The image forming apparatus according to claim 1, wherein the drawer unit comprises:
a fixing unit; and
a reversal conveyance path.

3. The image forming apparatus according to claim 1, further comprising a lock mechanism to switch the front cover, in a state in which the front cover is closed relative to the image forming apparatus, between a locked state that immobilizes the front cover and an unlocked state that allows the front cover to move.

4. The image forming apparatus according to claim 3, wherein the lock mechanism comprises:
a stationary member fixed to the image forming apparatus;
a pick rotatably provided to the front cover, a position of the pick being switched by rotation thereof, in a state in which the front cover is closed, between a locked position in which the pick engages the stationary member to switch the state of the front cover to the locked state and an unlocked position in which the pick is disengaged from the stationary member to switch the state of the front cover to the unlocked state; and
an operating member that rotates the pick between the locked position and the unlocked position.

5. The image forming apparatus according to claim 3, further comprising:
an interlock switch to control operation of the image forming part; and
a switching member provided to one of the drawer unit and the front cover,
the switching member turning on the interlock switch when the lock mechanism is in the locked state and turning off the interlock switch when the lock mechanism is in the unlocked state.

6. The image forming apparatus according to claim 1, further comprising:
an interlock switch to control operation of the image forming part; and
a switching member provided to one of the drawer unit and the front cover,
the switching member turning on the interlock switch when the front cover is closed and turning off the interlock switch when the front cover is opened.
